(19) United States
(12) Patent Application Publication
(10) Pub. No.: US 2026/0230752 A1
(43) Pub. Date: Aug. 6, 2026

(54) GROUND DIRECTED SPEAKER SYSTEM

(71) Applicant: Lunatics LLC, Miami, FL (US)

(72) Inventors: Jorge Perdomo, Miami, FL (US); Robert Trinanes, Bridgewater, MA (US)

(21) Appl. No.: 19/454,364

(22) Filed: Jan. 20, 2026

Related U.S. Application Data
(60) Provisional application No. 63/747,324, filed on Jan. 20, 2025.

(51) Int. Cl. H04R 5/02; G03B 21/14; H04R 1/02; H04R 5/04; H04R 27/00; H04S 7/00

(52) U.S. Cl. CPC H04R 5/02; H04R 1/026; H04R 5/04; H04R 27/00; H04S 7/302; G03B 21/145; H04R 2201/401; H04R 2201/403; H04S 2400/11

(57) ABSTRACT

A speaker system, comprising at least one subwoofer speaker, suspended at least 6 feet over a ground or floor, and having an acoustic emission directed toward the ground or floor, producing a uniform sound pattern at 20 Hz, substantially without constructive or destructive interference that leads to intensity variations over ±3 dB. The speaker may be relocated vertically with respect to the ground or floor, for example over a distance of about 1 meter. The relocation may occur during sound output. The subwoofer speaker may be provided in a monoblock speaker array, supported by a platform on a set of columns. The platform may also support a projection system for a light show, such as lasers, light emitting diodes, etc. The speakers or platform may produce acoustic waves during movement, and advantageously, these waves are synchronized or coordinated with the sound output.

### CROSS REFERENCE TO RELATED APPLICATIONS

The present application is a non-provisional of, and claim benefit of priority from, U.S. Provisional Patent Application No. 63/747,324, filed Jan. 20, 2025, the entirety of which is expressly incorporated herein by reference.

### FIELD OF THE INVENTION

The present invention relates to the field of audio and public address systems for events, and more particularly to a system having dynamically moving speaker elements.

### INCORPORATION BY REFERENCE AND INTERPRETATION OF LANGUAGE

Citation or identification of any reference herein, in any section of this application, shall not be construed as an admission that such reference is necessarily available as prior art to the present application. References to Internet web pages are intended to incorporate the entire content of the respective web page as of the filing date hereof. The disclosures of each reference disclosed herein, whether U.S. or foreign patent literature, or non-patent literature, are hereby incorporated by reference in their entirety in this application, and shall be treated as if the entirety thereof forms a part of this application.

All cited or identified references are provided for their disclosure of technologies to enable practice of the present invention, to provide basis for claim language, and to make clear applicant's possession of the invention with respect to the various aggregates, combinations, and subcombinations of the respective disclosures or portions thereof (within a particular reference or across multiple references). The inventor possesses all of the aspects disclosed in the cited and incorporated references, in combination and all permutations of the aspects explicitly disclosed herein. The citation of references is intended to be part of the disclosure of the invention, and not merely supplementary background information. The incorporation by reference does not extend to teachings which are inconsistent with the invention as expressly described herein (which may be treated as counter examples), and is evidence of a proper interpretation by persons of ordinary skill in the art of the terms, phrase and concepts discussed herein, without being limiting as the sole interpretation available.

The present specification is not to be interpreted by recourse to lay dictionaries in preference to field-specific dictionaries or usage. Where a conflict of interpretation exists, the hierarchy of resolution shall be the intrinsic evidence comprising the specification, references cited for propositions, incorporated references, and then extrinsic evidence comprising the inventors'prior publications relating to the field, academic literature in the field, commercial literature in the field, field-specific dictionaries, lay literature in the field, and general purpose dictionaries. Where the issue of interpretation of claim amendments arises, the hierarchy is modified to include arguments made during the prosecution and accepted without retained recourse.

### BACKGROUND OF THE INVENTION

Public address and event speaker systems are well known. Such systems typically have speakers located at the periphery of an event space, with the drivers facing toward the crowd space. Speaker elements may also be placed in the walls or ceilings, and low frequency drivers placed on the floor.

Electronic music concerts can become uncomfortable because everyone gets packed in the front. People do this for two reasons: to get as close as possible to both the artist, and to get as close as possible to the subwoofers, which give the most body feel of the sound.

This is suboptimal because we as humans are evolutionarily designed to dance/connect/gather in a circle. The first gatherings of community and culture were around bonfires. Where people could dance and see the eyes, smiles, faces of the people around them, creating a community. No reasonable human would say they prefer to dance looking at the back of another person's head. Eye contact in the circle of fire is deeply ingrained in our community genetics.

Low frequency music is the most powerful and noticeable part of an electronic music show. Sound is not just sound perceived by the ears; it is a pressure wave which is felt by guests on their bodies—it is felt on their skin and viscera. The stronger the pressure wave the more unique and special the experience for the customer.

Prior to use, often in an empty venue, the speakers are equalized and the loudness normalized. Rarely, the speaker array is tuned when the venue is occupied. The settings from the sound check are maintained through the event, or for static speaker systems, maintained over the course of several events or as a room setting. Because of this, speakers are located in defined positions, such as front-left, front-right, rear-left, rear-right, and other locations depending on the setup. Once assigned a location, the speakers are immobile.

The Meyer Sound TM Array (2008), used by Metallica for in-the-round concerts, employs four separate vertical columns of subwoofers flown above the drummer like a big stick, that radiate horizontally outward to achieve omnidirectional coverage through acoustic summation at listening positions. The boxes are placed as closely together as possible to help the phase-alignment. They radiate the low end like an antenna and provide the same amount of low-end energy everywhere in the room. The TM Array is actually nothing but a line array in the vertical, and a point source in the horizontal. Line arrays in theory are based on omni-directional sources, placed relatively close together, so subwoofers are the perfect choice for building a line array just by their nature. The vertical coverage is controlled by the (vertical) length of the array. Ten boxes, which is a length of about six meters, provide a good directivity down to frequencies of about 45 to 50 Hz. In the horizontal, the goal was to create something that had a perfect 360-degree coverage with no hot, or dead, spots. The horizontal dimension of the array were smaller than the reproduced wavelength in order to keep it omni-directional. The individual sources were closer together than one third of the shortest wavelength, in order to avoid creating destructive interference between the sources. This also made the array efficient, because energy is not lost due to cancellation between the sources. www. prosoundweb. com/how-the-tm-array-for-subwoofers-works/

U.S. Pat. No. 4,182,931 describes a floor-standing speaker system with a bass speaker mounted facing downward through an aperture with the casing supported by legs spacing the speaker from the floor. Sound from the down-firing driver reflects from floor in a 360 degree pattern. Two speakers are driven 180 degrees out-of-phase to prevent resonance. While U.S. Pat. No. 4,182,931 discusses down-firing bass for 360-degree floor-reflected coverage, this is a floor-standing single speaker unit for consumer/home audio, not an overhead suspended multi-enclosure monoblock, e.g., for concert-scale applications.

U.S. Pat. No. 5,451,726A/U.S. Pat. No. 5,306,880A describe a ceiling-mounted speaker system that is suspended from a structural member of the ceiling by safety wires with coaxially positioned, downwardly directed woofer and tweeter speakers that projects high-fidelity sound throughout a 360 degree angle in a horizontal plane. This establishes ceiling-suspended, down-firing speakers for 360-degree coverage. However, it describes a single commercial/installed audio unit for background music applications, not a multi-enclosure coupled monoblock for high-SPL.

U.S. Pat. No. 9,986,338B2 describes downward-firing and sideward-firing drivers for Dolby Atmos-type object-based audio systems, with “speakers mounted on ceiling firing downward” combined with wall reflections to create height perception in home theater environments, for home theater height channel simulation using reflections, not concert-scale omnidirectional bass reproduction.

Professional audio manufacturers produce flyable subwoofer products with integrated rigging hardware. However, these are designed for conventional deployment (typically flown with or behind line arrays in forward-firing configurations). Representative products include: L-Acoustics: KS28 (dual 18″, flyable up to 16 cabinets), SB18m, dV-SUB; D&B Audiotechnik: V-SUB, KSL-SUB; Meyer Sound: 700-HP, 1100-LFC (used in TM Array); JBL Professional: VTX S28, VTX B28 (flyable up to 16 enclosures); and Martin Audio: SXHF 218, SXCF 118/SXCF115 (cardioid flown subwoofers). Documentation for these products show they are designed for forward-firing deployment integrated with line arrays.

See, L-Acoustics White Paper: “Flown Subwoofers Do Not Generate More Noise” (2023), www.l-acoustics.com/wp-content/uploads/2023/02/WP-Noise-Pollution.pdf; Electro-Voice: “Subwoofer Arrays” Technical Document (2010), www.electrovoice.com/media/downloads/wp_subwoofer_arrays_v04.pdf

Typically, a speaker system is implemented to create an aural soundscape with virtual sources encoded within the audio program, such as a soundstage location of a vocalist, instrumentalist, etc. Therefore, the location encoding has traditionally been the task of the recording engineer, based on a generally true presumption that the recreation audio array will create a synthetic soundscape from a stereo, quadraphonic, 5+1, 7+1, 9+1, etc. array of speakers which are non-directional. That is, the perceived location of a sonic event in a soundscape is not strongly defined solely by the physical location of the speakers, and therefore that so long as the physical array is outside of the code listening area, the perceived audio program will correspond to what the sound engineer defined. en.wikipedia.org/wiki/Stereophonic_sound; en.wikipedia.org/wiki/Surround_sound; en.wikipedia.org/wiki/Quadraphonic_sound

So-called spatial audio goes further, and seeks to present to a listener an audio program independent of head orientation and location, similar to the effect of wearing headphones. Indeed, even with headphones, spatial audio techniques can provide front and read audio cues. en.wikipedia.org/wiki/3D_audio_effect; en.wikipedia.org/wiki/Head-related_transfer_function

The present invention provides moving speakers within an environment, and typically having relatively close distance to listeners and large range of movement, such that the listener perceives the actual location of the speaker as being the source of the sound, and the movements of the speaker are perceptually relevant to the listening experience.

Various means for relocating speakers and the like are known, such as rotary electric motors (AC or DC or stepping or servo) which can drive a pulley, toothed gear, worm gear, winch/cable, etc.; hydraulic or electrohydraulic actuator; pneumatic or electropneumatic actuator; linear electric motors; magnetic actuators, and the like. en.wikipedia.org/wiki/Electric_motor; en.wikipedia.org/wiki/Hydraulic_machinery; en.wikipedia.org/wiki/Hydraulic_cylinder; en.wikipedia.org/wiki/Pneumatic_actuator.

Various means for controlling movement of a displaceable element are known, including setpoint controllers, proportional-integral-differential controllers, proportional-integral controllers, artificial intelligence controllers, fuzzy logic controllers, and the like. Typically, the mass of the speakers and the speed of the movement will preclude a precise direct control over speaker location without feedback or system model, and rather the momentum of the moving speaker housing must be compensated in the control, in order to achieve efficient operation, cost-effective implementation, and acceptable results. Further, the drive system for repositioning the speaker housings may produce various noises, which may be intrusive or unacceptable. The control may therefore model and exploit the noise of the mechanisms as part of the intended soundscape that the listeners experience. en.wikipedia.org/wiki/Motion_control; en.wikipedia.org/wiki/Motor_controller

The speakers are preferably of known electrodynamic driver type, which is a voice coil and open or closed core magnet, and cone, though other types of speakers may be used. Balanced Armature Drivers, Planar Magnetic Drivers, Electrostatic Drivers, and Ribbon Drivers are alternates. en.wikipedia.org/wiki/Loudspeaker

Typically, permanent magnets and steel yoke structures of speakers that have effective emissions below 250 Hz, horn radiators, and damped resonance cabinets have significant mass, and thus raise inherent repositioning issues when large scale movements are effected.

Various types of sensors, for safety and system operation feedback are known. These may include video, radar, lidar, ultrasonic, optical/digital, optical/analog, resistive, capacitive, inductive, etc. See en.wikipedia.org/wiki/Position_sensor, en.wikipedia.org/wiki/Velocity_receiver, en.wikipedia.org/wiki/Accelerometer; www.ifm.com/us/en/category/250_020_020; Scholz, Constantin, Hoang-Long Cao, Emil Imrith, Nima Roshandel, Hamed Firouzipouyaei, Aleksander Burkiewicz, Milan Amighi et al. “Sensor-enabled safety systems for human-robot collaboration: A review.” IEEE Sensors Journal (2024), ieeexplore.ieee.org/stamp/stamp.jsp?arnumber=10758369; Li, Peng, and Xiangpeng Liu. “Common sensors in industrial robots: A review.” In Journal of Physics: Conference Series, vol. 1267, no. 1, p. 012036. IOP Publishing, 2019, iopscience.iop.org/article/10.1088/1742-6596/1267/1/012036/pdf

The IEEE-802.11bf standard exploits the ability of radio frequency emissions to interact with their environment to provide sensing within the space surrounding the antenna array. This can be used to detect occupancy of a venue, gestures, objects, and the like. Other optical, radar, lidar, sonar, and mechanical sensors are also available to sense the operating environment.

In arenas and theatres, and other multipurpose venues, speaker systems may be moved as part of setup and breakdown. However, when the speakers are intended to be operational, they are static. www. l-acoustics. com/customer-stories/state-farm-stadium/; www. qsys. com/products/solutions/applications/sport-venues/sports-venue-solutions-outdoor-stadiums/; www. audioholics. com/news/holoplot-x1-matrix-array.

Therefore, a large variety of technologies relevant to implementation and use of the invention is available.

See, U.S. Patent and Published Patent Application Nos. 4,230,905; 4,350,847; 4,403,112; 4,596,034; 5,000,286; 5,097,513; 5,129,006; 5,172,415; 5,191,618; 5,199,075; 5,313,525; 5,339,362; 5,384,855; 5,386,473; 5,408,533; 5,504,819; 5,537,479; 5,581,621; 5,625,696; 5,666,424; 5,687,239; 5,739,457; 5,745,584; 5,754,663; 5,809,150; 5,862,230; 5,870,484; 5,889,506; 5,937,074; 5,970,152; 5,983,087; 6,075,868; 6,081,783; 6,130,954; 6,133,656; 6,195,435; 6,240,189; 6,257,365; 6,311,155; 6,332,029; 6,339,649; 6,359,994; 6,385,322; 6,408,079; 6,501,832; 6,529,787; 6,584,204; 6,657,574; 6,683,962; 6,707,889; 6,792,086; 6,801,631; 6,849,794; 6,888,929; 6,931,134; 6,968,068; 6,975,731; 6,985,594; 7,006,164; 7,065,287; 7,190,796; 7,308,027; 7,330,552; 7,415,120; 7,443,987; 7,447,321; 7,451,006; 7,457,397; 7,530,424; 7,760,890; 7,760,899; 7,801,569; 7,895,783; 8,086,448; 8,175,318; 8,208,647; 8,508,572; 8,638,946; 8,873,788; 9,098,731; 9,106,192; 9,219,460; 9,219,807; 9,235,552; 9,264,839; 9,347,756; 9,368,101; 9,444,565; 9,449,590; 9,525,931; 9,538,305; 9,668,049; 9,690,271; 9,690,539; 9,693,164; 9,693,165; 9,706,323; 9,715,367; 9,743,207; 9,749,747; 9,749,763; 9,763,018; 9,794,710; 9,820,024; 9,860,630; 9,860,662; 9,860,670; 9,864,574; 9,872,121; 9,891,881; 9,930,470; 10,003,899; 10,075,804; 10,091,584; 10,127,006; 10,143,921; 10,284,983; 10,299,061; 10,372,406; 10,425,721; 10,459,684; 10,469,949; 10,484,784; 10,506,361; 10,516,959; 10,573,321; 10,585,639; 10,602,268; 10,664,224; 10,681,463; 10,687,145; 10,734,965; 10,756,433; 10,828573; 10,924,853; 10,998,615; 11,095,983; 11,106,423; 11,170,751; 11,206,484; 11,242,097; 11,256878; 11,265,358; 11,368,786; 11,425,522; 11,520,550; 11,540,049; 11,545,130; 11,658,631; 11,743588; 11,758,318; 11,856,275; 11,902,773; 11,968,495; 12,175,161; 12,185,083; 20010008100; 20010023792; 20010031060; 20020017567; 20020030094; 20020094097; 20020106088; 20020124271; 20020146139; 20020159610; 20030023429; 20030028273; 20030031329; 20030037490; 20030047377; 20030083024; 20030110929; 20030118192; 20030118194; 20030138106; 20030179892; 20030209384; 20030210795; 20030228027; 20040003705; 20040013271; 20040032536; 20040062401; 20040062404; 20040086128; 20040131192; 20040142739; 20040142747; 20040142748; 20040157555; 20040175015; 20040226433; 20040252851; 20050013442; 20050018856; 20050031117; 20050031129; 20050031130; 20050031131; 20050031132; 20050031133; 20050031134; 20050031135; 20050031137; 20050031138; 20050031139; 20050031140; 20050031143; 20050047619; 20050047622; 20050047850; 20050063552; 20050063554; 20050078840; 20050083486; 20050111579; 20050111580; 20050111581; 20050113040; 20050117669; 20050126364; 20050126372; 20050126378; 20050141627; 20050143004; 20050149322; 20050169494; 20050175197; 20050177463; 20050179489; 20050180579; 20050190925; 20050190936; 20050201571; 20050201583; 20050213786; 20050222844; 20050259831; 20050265172; 20050276420; 20050281429; 20060005694; 20060007358; 20060009285; 20060045294; 20060050890; 20060050892; 20060050894; 20060050907; 20060052167; 20060072776; 20060083383; 20060098827; 20060104451; 20060116073; 20060147057; 20060147067; 20060147075; 20060147077; 20060153391; 20060153399; 20060165247; 20060165250; 20060195314; 20060204017; 20060204022; 20060256976; 20060268363; 20060285695; 20070019826; 20070025557; 20070030979; 20070032895; 20070041586; 20070080264; 20070096812; 20070133810; 20070160256; 20070162257; 20070242834; 20070242844; 20070270988; 20070297616; 20080025549; 20080049948; 20080053287; 20080099273; 20080118078; 20080137894; 20080175397; 20080192952; 20080212805; 20080247553; 20080262850; 20080318518; 20090003613; 20090060221; 20090060227; 20090079690; 20090086995; 20090087008; 20090120264; 20090180646; 20090190773; 20090214051; 20090221369; 20090226019; 20090245539; 20090257601; 20090290064; 20090312849; 20090316930; 20100027819; 20100040254; 20100041443; 20100124345; 20100150359; 20100220874; 20100241256; 20100246833; 20100246839; 20100260483; 20100303263; 20100320819; 20100322441; 20100324711; 20110028218; 20110081024; 20110103590; 20110116551; 20110143837; 20110148521; 20110150242; 20110228959; 20110243364; 20110249819; 20110317849; 20120028577; 20120039476; 20120047435; 20120051579; 20120076324; 20120117839; 20120121092; 20120148074; 20120180093; 20120183162; 20120183167; 20120213375; 20120237069; 20120250870; 20120250912; 20120282997; 20120300176; 20130064388; 20130064389; 20130108099; 20130128119; 20130138233; 20130148823; 20130156225; 20130163787; 20130179535; 20130198786; 20130236032; 20130246327; 20130246778; 20130266173; 20130268281; 20130308800; 20130322461; 20130322462; 20130322633; 20140010380; 20140037117; 20140044268; 20140050325; 20140064519; 20140098980; 20140112497; 20140133683; 20140139738; 20140153744; 20140172557; 20140174277; 20140177870; 20140177896; 20140180684; 20140185812; 20140190481; 20140193016; 20140233747; 20140270263; 20140270306; 20140270696; 20140282389; 20140282748; 20140286510; 20140307907; 20140320662; 20140324202; 20140324299; 20140324757; 20140325569; 20140341394; 20140350944; 20140354441; 20140355765; 20140357368; 20140376725; 20150041554; 20150071451; 20150087404; 20150098597; 20150124973; 20150125025; 20150146873; 20150155839; 20150171973; 20150172817; 20150190726; 20150201255; 20150201279; 20150201295; 20150208190; 20150223002; 20150237424; 20150237446; 20150264483; 20150271620; 20150287400; 20150289037; 20150289038; 20150289057; 20150289058; 20150289059; 20150296280; 20150300727; 20150304791; 20150312468; 20150350804; 20150350805; 20150356889; 20150358734; 20150365775; 20150382090; 20160002939; 20160007129; 20160014516; 20160037282; 20160063984; 20160084493; 20160085499; 20160088036; 20160112212; 20160117885; 20160150313; 20160157016; 20160162015; 20160174009; 20160174011; 20160203811; 20160219364; 20160226610; 20160239255; 20160316296; 20160330562; 20160335041; 20160336014; 20160337750; 20160337779; 20160358251; 20160366521; 20170023685; 20170026768; 20170033755; 20170034621; 20170034623; 20170048606; 20170055055; 20170064295; 20170078823; 20170086008; 20170099557; 20170099558; 20170118454; 20170127035; 20170127206; 20170136842; 20170170908; 20170180863; 20170201779; 20170201828; 20170207750; 20170220315; 20170228258; 20170230753; 20170238114; 20170242653; 20170242656; 20170243596; 20170251298; 20170270734; 20170289509; 20170300289; 20170325039; 20170354574; 20170374484; 20180004840; 20180040324; 20180054174; 20180054776; 20180063665; 20180067714; 20180077491; 20180088895; 20180109837; 20180109894; 20180126263; 20180146281; 20180146290; 20180166062; 20180181365; 20180190307; 20180192194; 20180220228; 20180242083; 20180256991; 20180259785; 20180262836; 20180262859; 20180277113; 20180278456; 20180284587; 20180288379; 20180288555; 20180295461; 20180310095; 20180317001; 20180317004; 20180329480; 20180342106; 20180348855; 20180352365; 20180367939; 20190020963; 20190045296; 20190045306; 20190052967; 20190058949; 20190089950; 20190090020; 20190090051; 20190090059; 20190125087; 20190131947; 20190176982; 20190215349; 20190215583; 20190215634; 20190221082; 20190222926; 20190245503; 20190253801; 20190261621; 20190270023; 20190270029; 20190277017; 20190279605; 20190289285; 20190289417; 20190300020; 20190310820; 20190320281; 20190338837; 20190343253; 20190347063; 20190378385; 20200007987; 20200021939; 20200029150; 20200051370; 20200051374; 20200051377; 20200051388; 20200066266; 20200083856; 20200084544; 20200086223; 20200092637; 20200098386; 20200105256; 20200105295; 20200107110; 20200107646; 20200110571; 20200125162; 20200127374; 20200162821; 20200178016; 20200213662; 20200213801; 20200222276; 20200244242; 20200250588; 20200258512; 20200258513; 20200289922; 20200314537; 20200327878; 20200349935; 20200354220; 20200360651; 20200366124; 20200367006; 20200368491; 20200389129; 20200389714; 20200395908; 20200396527; 20210065720; 20210067875; 20210086704; 20210089265; 20210092520; 20210120331; 20210126748; 20210136494; 20210144506; 20210152940; 20210152963; 20210174535; 20210185471; 20210197667; 20210200506; 20210201624; 20210204057; 20210208839; 20210211038; 20210211118; 20210235192; 20210257983; 20210297772; 20210311688; 20210319663; 20210329330; 20210338969; 20210345939; 20210392431; 20210401673; 20220046374; 20220053281; 20220086562; 20220113933; 20220117837; 20220122583; 20220124399; 20220124432; 20220124447; 20220129652; 20220131711; 20220148592; 20220164162; 20220166396; 20220176165; 20220201057; 20220210588; 20220232262; 20220238120; 20220244134; 20220246070; 20220246163; 20220247939; 20220248139; 20220286741; 20220286779; 20220303636; 20220303668; 20220311358; 20220316974; 20220329959; 20220329998; 20220334025; 20220337937; 20220337965; 20220339536; 20220357834; 20220358818; 20220360868; 20220381892; 20220385991; 20220386018; 20220387903; 20230007752; 20230008214; 20230009189; 20230018052; 20230024299; 20230035692; 20230039530; 20230049670; 20230068527; 20230188893; 20230199504; 20230201727; 20230217059; 20230232150; 20230235525; 20230239446; 20230239646; 20230269528; 20230274623; 20230316852; 20230319459; 20230319465; 20230319478; 20230336911; 20230360665; 20230362532; 20230362536; 20230362545; 20230362546; 20230362578; 20230370777; 20230388685; 20230396504; 20230412868; 20230421952; 20240001068; 20240004434; 20240008628; 20240015445; 20240015468; 20240029755; 20240031735; 20240031738; 20240040303; 20240061643; 20240062078; 20240064484; 20240073603; 20240080594; 20240088693; 20240098441; 20240098448; 20240104151; 20240115201; 20240147184; 20240163594; 20240163626; 20240163629; 20240168555; 20240172949; 20240196150; 20240219950; 20240223945; 20240223978; 20240236612; 20240249715; 20240249740; 20240256217; 20240259761; 20240265921; 20240267677; 20240296822; 20240297959; 20240298066; 20240298110; 20240298129; 20240323627; 20240345703; 20240357279; 20240406495; 20240406657; 20240420674; 20240422493; 20240426994; 20240430637; 20250012663; 20250013133; 20250024219; and 20250024220.

### SUMMARY OF THE INVENTION

The present invention provides loudspeaker elements within a venue for audio reproduction, controlled such that the location of the loudspeaker is a significant perceived audio cue. The speakers may be mounted for movement during a performance, to adjust a distance between the speakers and the ground or floor. The speakers are typically around a listening space, and may move from the sides or top. The movement is typically at least 20 cm, and perhaps 300 cm, with such movements having significant amplitudes at spectral frequencies of 0.01-3 Hz. That is, a speaker may reposition in a time on the order of 0.33 to 10 seconds. Speakers may be maintained at a safe distance from listeners, or intrude into the listening space with sensors and failsafe mechanisms to assure listener safety. Therefore, where the range of movements intersects with the theoretical occupancy zone or region, the speaker movement may be adaptive to the actual occupancy or obstruction profiles. On one hand, the speaker movements are effected to avoid danger or hazard, but on the other hand, where there are no listeners affected by the speakers, the movement may be ceased to reduce wear, power consumption, etc. Note that, where the speaker enclosures are part of a visual show, the movements may be continued for that reason independent of acoustics.

The listening venue is typically a club, theatre, arena, or other large scale venue, though this may also be applied to personal listening situations. The speakers advantageously may be suspended from a superstructure above a listening space, and typically have a vertical movement of at least 1 meter, and perhaps as much as 5 meters. The speakers may remain at least 6-8 feet over the floor, or extend lower, with safety sensors to avoid collisions or other unintended interactions with humans. Typically, the speakers are maintained over the heads of the listeners, and therefore 7-8 feet minimum height is preferred. Where listeners are short, such as children, the height may be 6 feet or below. With a crowd of adults, a minimum height of 7-8 feet is safer. Of course, with expected effect, the speakers may be suspended higher, such as 8-12 feet above the floor. Because of the interaction of the speaker, especially a down-firing speaker (e.g., subwoofer) with the ground surface, an acoustic sensor (e.g., a microphone, vibrometer, pressure sensor, etc.) may be used to provide feedback of that interaction, which is frequency dependent and may be resonant. More generally, the feedback from the sensor may provide input to an adaptive equalizer. Note that the speaker movement is intended to produce a dynamic experience for the listener, so the equalizer is not intended to fully compensate for the variations, and in one embodiment is intended to exploit visceral effects of low frequency resonances. Therefore, as the key of the music changes, the speaker height may be adjusted to ensure resonance in that key. Of course, to provide a contrast, in some musical passages, the speaker or speaker array may be adjusted to avoid resonances.

Since the system typically has a number of speakers, which may be independently operable, the controller may play different portions or versions of the music through different speakers. Thus, the notes or waves of a progression may be perceived to be coming from different locations, with the different speakers having different resonances and ground effects. The wavelength of 20 Hz sound at 20° C. in air is about 17.15 meters. Constructive interference therefore occurs at about 8.58 meters from a reflective surface. At 40 Hz, the wavelength is about 8.58 meters, and constructive interference would occur by interaction with reflective surface or scatterer about 4.29 meters away. These distances vary based on temperature and pressure, and the acoustic emission and interaction is not one-dimensional and also depends on various objects and acoustic interactions with objects. Therefore, over a range of acoustic and subacoustic waves, from 5 Hz to 200 Hz, the perceptible effects of the feasible movements of the speakers during a performance are significant.

Where the speakers are mobile, they may also be moved horizontally along one or more axes (x,y,z), and may be rotated about three axes (θ,φ,ψ). For example, the system may have three linear degrees of freedom and three rotational degrees of freedom. Further, the speaker may be provided on an articulated arm, which may provide other independent degrees of freedom. Speakers with different frequency characteristics may have different movements. For example, down-firing subwoofers may have movements limited to a vertical axis, while mid and high frequency speakers may move horizontally. A head-related transfer function may be used to predict or define the directional and movement influences on the perceived sound by one or more listeners.

The control system may have head and ear tracking functions, and provide spatialized audio customized for one or more listener, based on a head-relate transfer function of each listener, the position of the listener, and objects (including other listeners) in the soundscape.

The control over speaker movement may be manual, such as by switches, rotary knobs or sliders, touchscreen controls, hand gesture tracking, and the like. A set of electronic stops on the controls may define a safe zone of movement, i.e., top, bottom, velocity or velocity profile, in addition to physical limits on the movement. Typically, the speakers themselves are moved by automated systems, controlled based on the audio program (e.g., with a lookahead buffer to ensure that speakers are positioned correctly at the beginning of a passage or tone) or a predefined choreographed script (which may have feedback inputs and adaptively controlled outputs). In most cases, the energy source will be electrical, possibly through mechanical, pneumatic or hydraulic intermediate elements. However, it is also possible to store potential energy, such as in a compressed gas cylinder, spring, elevated mass, etc., to provide energy for relocating the speakers over time. A counterbalance or accumulator system may be used to equalize motor load during up and down movements.

The manual or automated control over the movement of the speakers may be controlled by or synchronized with the music coming from the speakers, in the manner of a DMX-controlled light rig. The movement may be based on amplitude patterns, e.g., crescendos, frequencies or instruments contemporaneously playing, rhythms, visual patterns in the environment (lights or dancers on dance floor), etc. The system may support both manual and automatic movement control, and may have intelligence to extract a movement pattern or paradigm from the user interface to replicate or continue the pattern or paradigm. In some cases, there may be multiple users controlling the movements, and in that case, there may be some automatic coordination or separation of responsibilities between the users.

The distance between the down-firing subwoofer array and the listeners may be adjusted for different songs, portions of songs, or the like. The distance adjustment provides an independent control over the experience from the amplitude of the drive signal, and both may be advantageously adjusted to achieve the desired effect. The sound pressure level in a festival event may be 100-105 dB.

If the speakers intrude into a zone in which humans might be present, a model-based controller may model each listener that is within a collision/interaction risk zone, including dynamic movements and a range of potential movements. The main sensors here are optical/video sensors, though radar sensors may also be used, especially if fog effects may be used. (Video sensors may raise a privacy issue, and therefore may be avoided in non-public venues). The movement of the speakers is constrained to avoid collision risk, for example by computing a 99%, 99.9%, or 99.99% confidence interval of the predicted and potential movements of one or more listeners, and maintaining the speaker outside of this region, on a dynamically updated basis. (In the case of a 99% confidence interval, a 1% risk of collision is typically unacceptable, and therefore ancillary safety protocols are implemented as well, such as real-time sensing). The rate of updates and movements is based on the speed of speaker movement, as well as the crowd movements. Assuming, for example, that the speaker system is suspended above a dance floor, when the floor is uncrowded, the speakers may be suspended less than 6 feet from the floor and in positions that avoid unintended collisions or intersection with listeners; when the floor is crowded, the speakers will be maintained above 8 feet, to avoid need to fine-grained collision sensing.

In one mode, the speakers may be provided at an overlapping height with the listeners, so that the listeners can “dance” with the speakers, and the speakers controlled to engage in a rhythmic movement emulating a dance, along 1-6 or more axes of movement.

In accordance with an embodiment of the invention, a speaker system is provided as part of an entertainment system. The system provides a platform suspended above a listening space by a set of columns from below and/or cables from above. Typically, the platform and its suspension are non-critical, though some embodiments integrate functional components within the platform and/or its suspension. The suspended speakers create a 360-degree sound space, which is perceived differently from a set of subwoofers surrounding the user space.

Traditional sound systems typically avoid suspending subwoofers over the listeners, for at least two reasons. Subwoofers tend to be heavy, due to the cabinet and sound path, and the speaker element itself tends to have a long throw actuator. Further, about 50% of the perceived power is lost when the subwoofer is above the ground due to loss of ground-plane reinforcement. However, raising the subwoofers overhead removes the problem of uneven subwoofer power in a 360-degree sound space (meaning, for example, that there is no front of the soundscape or that location within the venue does not change the sonic experience), as you can't simply place multiple subwoofer enclosures surrounding a space, directed in various directions, because they're more or less omnidirectional, and doing so would result in multi-point interference with null areas and reinforced areas. The downward firing subwoofers also create a unique body feeling as the powerful bass washes over people's bodies from head to toe.

This strategy also permits high level bass, while ensuring controlled mid and high frequency amplitudes to avoid pain and hearing damage. When the subwoofers are moved 4-5 feet closer to the heads of the listeners, the body shaking bass becomes about two times greater. Another benefit of the arrangement is that suspended subwoofers have less horizontal coverage, permitting high bass levels on a dance floor or the like, while providing attenuated noise outside of the dance floor.

In some embodiments, the subwoofers, optionally with other audio transducers, are suspended above a listening space, so that listeners are immersed in the sound waves. The speakers are preferably at least 6 feet off the ground or floor, and desirably above the listener's heads, such as 7-8 foot minimum height. The sound intensity of a subwoofer drops by about 6 dB per meter, so reduced distances lead to greater uniformity of sound pressure level as heard and felt by the listeners. That is, by moving the subwoofers overhead, rather than at ground level around the listening space, a qualitatively different effect is achieved than in typical layouts. Subwoofers placed near the floor offer a sound enhancement of about 6 dB, which is lost by having down-firing subwoofers overhead. A corollary is that the evenness of sound distribution is increased by having multiple overhead subwoofers instead of a few peripheral subwoofers.

Many have done 360-degree events before, but they've done them in two ways. First is that they put all the speakers in a circle around/under the artist pointing out. By doing so, by definition the subwoofers, as omnidirectional speakers, will have interference as different sources point in different directions and placed at different points will by definition clash at points resulting in destructive or constructive interference. There is no way to ensure a perfectly even spread of sound in 360 degrees without these interference points. Even if there was no clash, the sound system being on the center of the dancefloor consumes a large amount of the dancefloor itself and impedes the enjoyment space for people.

Subwoofers in a monoblock (two or more strapped together), suspended by a support structured pointing down, avoid the consumption of floor space by the speakers. By down-firing the subwoofers as a single block, they combine together to become a single source signal, and the signal hits the ground and washes in 360 degrees, naturally creating a full 360-degree dancefloor with no impediments to guests, artists, or anything underneath. Further, the feeling of sound coming down from above and enveloping people from top to bottom is radically different than being hit with sound from the front. All these things together create a novel and unique acoustic, corporal, and community experience. This orientation also results in the bass frequencies, which are usually the most disruptive to neighbors around an event (causing police complaints, shutdowns, conflicts, etc.) to propagate significantly lower distances. By dividing the power in 360-degrees and not shaking the ground itself (by installing the subwoofers on the ground), this can be a system to control bass noise complaints in itself.

Because subwoofers are physically large and very heavy, there is a natural effort to avoid suspending them. Also, taking them off the ground makes them lose about 6 dB of ground plane reinforcement, which is about half the effective power of a system, so there is a further disincentive to achieve lower efficiency, as it will result in a smaller dancefloor for the amount of speakers/amplifiers available.

According to one embodiment, the suspended speakers specifically include subwoofers, i.e., speakers that produce sound below about 120 Hz, and extend to 20 Hz or below. Note that it is not required that the subwoofers be moveable, but such movement adds to the effect. In many cases, the subwoofers permit driving the sound into the infrasonic range, e.g., to 5 Hz or below. These subwoofers are directed downwards, directly toward the patrons. Note that suspended subwoofers are considered inefficient because they lose ground plane reinforcement, however, the direct effect of the directed low frequency waves produce a different effect from the diffuse low frequency emissions from floor-mounted subwoofers. The suspended subwoofers remove the problem of uneven subwoofer power in a large space, as it is impractical to put multiple subwoofer enclosures pointed in various directions, and because they're more or less omnidirectional, so doing so would result in significant multi-point interference based on frequencies, distances, and phase delays between speakers. This, in turn, could result in null areas where the low frequency sounds are cancelled, and others where the volume is unbearably loud. The downward-facing subwoofers allow an array of speakers with direct emission of low frequency sounds toward the listener, to create a unique body feeling as the powerful bass washes over people's bodies from head to toe. By establishing an array of overhead speakers, local audio amplitude for the listeners may be well-controlled and uniform. A particularly interesting effect is achieved by dropping a suspended speaker array by 4-5 feet over the listeners' heads, while normalizing the higher frequencies (100-20 kHz) and maintaining the bass (<100 Hz), which results in body shaking bass that becomes about two times stronger over the course of coming down, while avoiding significantly increased volume in the mid and upper range. Moving a subwoofer speaker 1 meter toward a listener will result in an increase of sound power of 6 dB.

The platform supports a set of speakers in enclosures, which are mounted for movement with respect to the platform. The speakers typically have at least a vertical motion capability, and may move together or independently. The speakers may also have other axes of movement, such as horizontal along one or two axes, radially along one or two axes, along a track which may have an arbitrary profile, or using a robotic actuator system.

One form of speakers comprises cone structures with a voice coil and magnet, generating a cardioid sound pattern, with a cone diameter of 5-21 inches. These types of speakers produce sounds over a frequency range of 10 Hz-5 kHz. For higher frequencies, a dome structure without a cone, driven by a voice coil or piezoelectric transducer is used. Other speakers use a horn or folded horn structure. Still other speakers provide a membrane electrode between a pair of porous plates to form an electrostatic speaker. A further type of speaker generates a plasma, and modulates the size of the plasma disturbance to emit acoustic waves. Most typically, cone or folded horn speakers are employed. Such speakers can each have significant mass, i.e., 0.5-300+ kg, with feasible arrays exceeding 2,000 kg. For example, an array may include down-fired subwoofers, down-fired monitors, mid-bass boxes and high frequency boxes arranged on a peripheral ring. The larger speakers have significant momentum, and therefore abrupt accelerations may be energy intensive.

In order to increase efficiency, regenerative braking may be employed, with or without resonant elements to store energy during decelerations of the moving mass.

For lower mass speakers, e.g., generally those less than 50 kg, directly controlled movement without consideration of energy efficiency of acceleration and deceleration or dynamic balancing may be employed. These speakers may be driven by AC motors, brushed or brushless DC motors, servomotors, stepping motors, hydraulic actuators, pneumatic actuators, etc.

For vertical motion, a cable or other tensile element, about a pulley or wheel, can be used to control the height of a speaker. Each speaker may be independently controlled, with the speakers forming a suspended dynamically changing array. For example, the speakers may form an array which defines a surface, and the surface may dynamically change in dependance on an audio program.

In order to provide a useful effect, the speakers should have a range of movement of at least 20 cm, preferably at least 40 cm, and more preferably at least 100 cm. The maximum speed of movement of the speakers is preferably at least 3 cm/sec, preferably at least 5 cm/sec, and more preferably at least 20 cm/sec. For example, the speaker array may be moved at a rate of 5 cm/sec for a range of 150 cm in 30 seconds. The speakers move according to an automated program and/or manual control, with characteristic frequencies between 2 Hz and 0.03 Hz (30 sec. to 2 per second rate). While these movements do not encompass audio frequencies, they do correspond to musical phrase durations and therefore are usefully synchronized with audio source characteristics.

Note that faster movement speeds and independent motion of speakers is possible, rather than moving the entire array as a unit.

The speakers may have associated sensors which detect or anticipate obstructions in their path of movement, and be controlled to avoid contact. This, in turn, allows the array of moving speakers to interact with an audience, and have movements that encompass a space in which the audience can potentially be present. Further, the movements of the speakers may respond to movement of the audience, and therefore this permits members of the audience to “dance” with the speakers.

The speakers may be outfitted with various types of lighting, and/or the lighting projected onto the speakers. Thus, a light show may accompany an acoustic program. Typically, the audio program will be predetermined (i.e., a recording) and therefore movements of the speakers may be predicted and scripted in advance. On the other hand, the system may also be used by live performers and/or run manually.

The platform may support a DJ or entertainer, and in that case, the platform is preferably in fixed position. The platform is typically supported by, e.g., 4 legs, but may have any number of legs or supports, and may be suspended from a ceiling, walls, or other structure. Alternately, the platform may be suspended from above, such as by cables from a ceiling. The platform may also have a variable height, though due to its mass and size, the movements of the platform are typically slow.

The speakers are not limited to vertical motions, and a speaker may rotate about a structure, or spin (if the sound is not output along the spin axis).

The speakers are arranged to be relocatable during a performance, and may be driven by various types of motors or actuators. Typically, a vertical axis of movement is employed, so that the distance between the speaker and a listener's ear(s) is changed by a significant distance or percentage. For low frequencies which have an omnidirectional emission, the sound intensity varies by 6 dB for each meter of distance from the source. The speakers may also have other axes of movement, such as within an x-y plane, a rotational movement along spherical coordinates θ-φ. The speaker may be moved using a robotic arm, for example having 2-6 controlled axes of movement.

It is therefore an object to provide an audio system, comprising: a monoblock speaker array maintained above an open space for congregation of listeners, comprising a plurality of subwoofers in an array defining a surface, each subwoofer being configured to emit sound directly downward toward the ground over frequency range of at least 30-60 Hz and being mounted in a subwoofer enclosure, the subwoofer enclosures being arranged in a two-dimensional array without intervening air flow space; and an amplifier for each respective subwoofer, wherein the monoblock speaker array is configured to subject the open space for congregation of listeners to a uniform sound pressure level of at least 90 dB over the frequency range of at least 30-60 Hz.

Each subwoofer may be configured to emit sound directly downward toward the ground over frequency range of at least 25-80 Hz, such as 20-100 Hz, and 20-125 Hz. In some cases, the sound pressure level may be measured at a single frequency, such as 35 Hz. Single frequency measurements are often useful where complex spatial effects may be present, such as in linear or spatial arrays of speakers. However, digital sequenced spread spectrum sources may also be used to track amplitude and phase delay over a range of frequencies. Typically, a frequency range of a speaker is measured in an anechoic chamber, with the ends of the range having less that ±3 dB from the median. For subwoofers, an anechoic chamber is impractical, and therefore the response may be measured in an open space with a low reflective ground.

The audio system may further comprise an actuator configured to change a height of the monoblock speaker array over the ground by a distance of at least 50 cm at a rate of at least 5 cm/sec while the monoblock speaker array is emitting sound. The actuator may comprise a plurality of coordinated motors configured to lift and lower the monoblock speaker array with a plurality of cables or screws. The actuator may be configured to move the monoblock speaker array along at least two different axes.

The audio speaker system may further comprise a control configured to synchronize a movement of the monoblock speaker array with a musical composition, to change a sound pressure level at a location of a listener in the open space by at least 3 dB.

The audio system may further comprise a sensor configured to determine an object in the open space, and a control system responsive to the sensor configured to control the actuator.

The audio system may further comprise a second speaker array configured to emit sound at a frequency of 500 Hz, the second speaker array surrounding the monoblock speaker array; and at least one amplifier configured to drive the second speaker array. Likewise, a third set of speakers may be provided configured to emit sound at a frequency of 2,500 Hz.

The audio system may further comprise an optical system controller configure to control an optically emissive visual effect.

It is also an object to provide an entertainment system, comprising: a plurality of speakers in a spatial array without an air gap therebetween, each being configured to emit sound at a frequency of 35 Hz directly downward; and a mechanism configured to support the spatial array over a floor area, wherein the spatial array is conjured to achieve a sound pressure level at the frequency of 35 Hz of at least 90 dB at the floor area.

The spatial array may be configured to achieve a sound pressure level over a range of frequencies of 25-80 Hz of at least 100 dB at the floor area.

The entertainment system may further comprise an automated control system, configured to control the automated mechanism to relocate the plurality of speakers while the speakers are emitting sound, based on a musical composition played through the plurality of speakers, while avoiding a collision with a listener on the floor area.

Another object provides a system, comprising: a speaker configured to emit sound at a frequency of 30 Hz; and an actuator, configured to change a height of the speaker with respect to the floor over a distance of at least 50 cm while the speaker is emitting the sound at the frequency of 30 Hz directly downward toward the ground.

The actuator may comprise a motor configured to lift and lower the speaker with at least one cable or screw.

The actuator may be configured to maintain the speaker at a height of 3 meters above the ground, and to vary a height of the speaker to change a sound pressure level at the ground by at least 3 dB at 30 Hz.

The actuator may be further configured to change the height of the speaker to a height of less than 2 meters above the ground.

The system may further comprise a control configured to coordinate a drive signal for the actuator with an acoustic signal for reproduction by the speaker.

The system may further comprise a sensor configured to determine an obstruction of a movement of the speaker, and a control system configured to control the actuator to move while avoiding the obstruction.

The system may further comprise an optical system controller configure to control an optically emissive visual effect in coordination with a movement of the speaker.

The system may further comprise a video camera configured to produce a video signal, and an automated control system configured to generate a control signal for the actuator to control a movement of the speaker dependent on the video signal.

A movement of the speaker may be constrained by a track.

The actuator may be configured to change the height of the speaker at a rate of at least 5 cm/S.

The actuator may be configured to change the height of the speaker over a sufficient distance to change a sound pressure level at a location between the speaker and the ground by at least 3 dB at 30 Hz.

The speaker may have a vertical axis of movement and a horizontal or rotational axis of movement, the system further comprising a motor control configured to independently control a path of the speaker along the vertical axis of movement and the horizontal or rotational axis of movement.

The speaker may have a rotational axis of movement.

The system may further comprise an automated motor control configured to move the speaker in coordination with a musical audio source input for the speaker.

The system may further comprise a sensor configured to determine and a motion or gesture of a human, and a control system configured to control the actuator to move the speaker coordinated with the motion or gesture of the human.

The system may further comprise: a second speaker configured to emit sound at a frequency of 30 Hz; and a second actuator, configured to change a height of the second speaker with respect to the floor over a distance of at least 50 cm while the second speaker is emitting the sound at the frequency of 30 Hz toward the ground, wherein the actuator and the second actuator independently control movement of the speaker and the second speaker.

The actuator may comprise a robotic arm having at least two degrees of freedom.

The system may further comprise a sensor configured to generate a sensor signal corresponding to presence of an obstruction, and an automated control configured to control the actuator to dependent on the sensor signal.

The system according may further comprise a control configured to synchronize a movement of the speaker by the actuator with a musical composition played by the speaker.

It is a further object to provide an entertainment system, comprising: a suspended platform over a floor area; a plurality of speakers, each being configured to emit sound at a frequency of 30 Hz, and each being relocatable over a distance of at least 50 cm at a rate of at least 5 cm/sec with respect to the platform and the floor area by an automated mechanism while the speaker is emitting sound, to thereby alter a perceived sound pressure level of the emitted sound by a listener on the floor area; and an automated control system, configured to control the automated mechanism to relocate each of the plurality of speakers while the speaker is emitting the sound at the frequency of 30 Hz, based on a musical composition played through the plurality of speakers, while avoiding a collision with the listener on the floor area.

The entertainment system may further comprise an illumination system, wherein the automated control system is further configured to control the illumination system based on the musical composition played through the plurality of speakers.

The automated control system may be further configured to independently control a height of at least two downward during subwoofer speakers of the plurality of speakers while the at least two speakers are emitting the sound at the frequency of 30 Hz

The automated mechanism may be configured to move at least one speaker in an arc speaker is emitting the sound at the frequency of 30 Hz.

It is a still further object to provide a musical performance method, comprising: receiving a musical composition; planning a set of vertical movements of a downward firing subwoofer to alter a perceived bass effect by a listener below the subwoofer; emitting the musical composition from the subwoofer; and change a height of the subwoofer according to the planned set of vertical movements by a distance of at least 50 cm while the subwoofer is emitting the musical composition.

A control system may be used to coordinate an acoustic signal for the speaker with a drive signal for the actuator. For example, an audio recording may be analyzed for musical phrasing that can be translated into movement parameters of the speakers. By analyzing the entire recording, both excursions and returns may be programmed. The movements may be dependent on notes, chord progressions, use of different instruments, rhythms, and the like.

The system may integrate a light show with the speaker movements. For example, LEDs may be provided on the speakers, which can be controlled with the movement of the speakers. The lighting may also provide projectors which light up the speakers, or light up the room from the speakers. A laser projector may also be used in conjunction with the moveable speakers. Laser projectors may pose a visual threat to patrons, and therefore non-eye-safe laser systems should not be directed toward the patrons. The movement controls for the speakers may coordinate the same zone boundaries for safety. Using real-time location sensors, the unoccupied areas of the venue may be mapped, which then can be intruded upon with physical speakers or laser emissions. The system may respond to predicted changes in occupancy, to permit adaptive and predictive reconfiguration which accounts for speaker movement latencies.

A video camera may be provided to provide real-time feedback of the environment. For example, if the platform is above a dance floor, the speakers may be controlled to extend onto the dance floor area, but avoid dancers. The speakers may also be controlled to “dance” with patrons, especially where the movement is controlled with respect to x, y, z axes plus various rotations θ, φ, ψ. The video camera may detect patron gestures, and respond to those gestures.

The actuator mechanism for the speakers may emit sounds during use. Advantageously, the emitted sounds are synchronized with the acoustic program, to mask the sounds.

It is therefore an object to provide a speaker system, comprising: a platform suspended above a floor; a speaker; and an actuator, configured to relocate the speaker with respect to the platform while the speaker is emitting sound.

The amount of movement may be >10 cm, >20 cm, >30 cm, >40cm, >50 cm, >75 cm, >100 cm, >133 cm, >150 cm, >167 cm, >200 cm, >250cm, etc. The speaker may be relocated at a rate of >10 cm/S, >15 cm/S, >20 cm/S, >25 cm/S, >30 cm/S, >40 cm/S, >50cm/S, >75cm/S, >100 cm/S, >150 cm/S, or >200 cm/S. The speaker may move at least 1 cm/S, 2cm/S, 3cm/S, 4cm/S, 5cm/S, 6 cm/S, 7 cm/S. 8 cm/S, 9 cm/S, or 10 cm/S, for example. Higher movement rates are possible, such as 15 cm/S, 20 cm/S, 25 cm/S, or 30 cm/S. The speaker may move at least 5 cm. 10 cm. 15 cm, 20 cm, 25 cm, 30 cm, 35 cm, 40 cm, 50 cm, 60 cm, 70 cm, 80 cm, 90 cm, 100 cm, 125 cm, 150 cm, 175 cm, 200 cm, 250 cm, or 300 cm. For example, the actuator may be configured to relocate the speaker at a rate of at least 3 cm/S over a distance of at least 20 cm while the speaker is emitting sound.

The relocation of the speaker may be adapted to produce an air movement coinciding with an electronic drive signal that drives the speaker array. That is, the actuator itself produces sound by moving the speaker and/or speaker enclosure to move air. The relocation of the speaker may have a sufficient speed and distance to generate a sound pressure of at least 60 dB at 30 Hz.

A control may be provided, configured to coordinate an acoustic signal for the speaker with a drive signal for the actuator.

The speaker may be moved vertically by the actuator. The speaker may be a subwoofer, adapted to produce sounds below 28 Hz.

The speaker may also be moved horizontally by the actuator.

The speaker may be moved rotationally by the actuator.

The speaker system may include an automated motor control configured to relocate the speaker in coordination with musical phrases.

The speaker may be moved along a 1D path (a linear movement) , a 2D path (a planar movement), a 3D path (a spatial movement), a 4D path (a spatial movement with angular control), a 5D path (a spatial movement with 2D angular control), or a 6D or higher path (e.g., spatial movement, with angular control and rotation).

The speaker may be moved at a subaudio frequency. The “frequency” of a movement refers to the dominant component(s) of a Fourier transform of the movement profile. For example, a speaker that reciprocates between two positions 1 second apart would have a frequency of 0.5 Hz (since it takes 2 second to return to the initial position, and the reciprocating movement is dominant over accelerations and decelerations).

A controller may be provided, configured to plan a movement of the speaker over time, at least five seconds in advance of controlling the movement.

The speaker system may further comprise a human user interface configured to receive a manual control signal for controlling a movement of the speaker.

The speaker system may further comprise a second actuator and a second speaker, the second speaker being configured to move independently of the speaker.

The actuator may operate a ball screw, a winch which controls the position of a cable, a telescoping assembly, a rack and pinion assembly, or a band driven by a wheel.

The speaker may be linked to a track, and the actuator may be configured to control a position of the speaker along the track.

The actuator may comprise a rotary motor.

The actuator may comprise a linear motor, a pneumatic cylinder, or a hydraulic cylinder.

The actuator may comprise a robotic arm having at least two degrees of freedom, three degrees of freedom, at least four degrees of freedom, at least five degrees of freedom, or at least six degrees of freedom.

The speaker may comprise a subwoofer. The subwoofer may be down-firing. The subwoofer may be provided within a monoblock, with the speakers or speaker enclosures being adjacent and forming a surface which blocks or impedes are flow between a front and rear of the monoblock.

The speaker may comprise a tweeter.

The speaker system may further comprise an optical projector. The actuator may be further configured move the optical projector in coordination with a movement of the speaker. A second actuator may be provided, configured move the optical projector independently of a movement of the speaker.

The actuator mechanism may be subject to acoustic emissions when active, and a control provided to receive an audio source signal, and to control a movement of the speaker such that the acoustic emissions of the actuator are masked by or coordinated with an output of the speaker associated with the audio source signal.

The speaker system may further comprise a video camera, and an automated control system configured to analyze a video signal from the video camera in real time to generate a control signal for the actuator to coordinate a movement of the speaker with movements within the video signal.

The speaker system may further comprise a sensor configured to generate a sensor signal representing an obstruction in a path of the speaker, and an automated control configured to control the actuator to prevent contact of the speaker with the obstruction during a movement of the speaker. The sensor may comprise a photodetector, a camera, a structured lighting emitter, an infrared sensor, or an ultrasonic sensor.

The speaker system may further comprise a control configured to synchronize a movement of the speaker by the actuator in synchrony with a musical composition played by the speaker.

Another object provides a platform which suspends a plurality of down-firing subwoofer speaker elements above a listening space, driven in synchronized fashion, substantially without constructive or destructive interference in the listening space.

The listening space may be a dance floor of e.g., at least 3 meters by 3 meters, and the listening space may have a uniform sound pressure level ±3 dB at 20 Hz at an output of 100 dB.

The listening space may be a dance floor of e.g., at least 4 meters by 4 meters, and the listening space may have a uniform sound pressure level ±2 dB at 20 Hz at an output of 100 dB.

It is another object to provide an entertainment system, comprising: a platform; a plurality of speakers, each speaker being relocatable with respect to the platform by an automated mechanism; an illumination system; and a control system, configured to control the automated mechanism and the illumination system, to move the speakers and alter an illumination from the illumination system based on a musical composition played through the plurality of speakers.

The illumination system may have an illumination emitter associated with each speaker, and the control system is configured to independently control a plurality of the illumination emitters.

The platform may be suspended above a floor, and the speakers are relocatable vertically from the platform.

The mechanism may comprise at least one cable associated with each speaker.

The mechanism may comprise at least one arm associated with each speaker.

The mechanism may comprise at least one arm having at least two controlled degrees of freedom controlling a movement of each speaker.

The illumination system may comprise a set of light emitting diodes, at least one light pipe, at least one fiber optic, or a laser projection system.

The automated mechanism may be configured to relocate at least one speaker at a rate of at least 2 cm/S. The automated mechanism may be configured to relocate at least one speaker over a distance of at least 20 cm while the speaker is emitting sound.

The automated mechanism may be configured to relocate at least one speaker at a rate of at least 20 cm/S over a distance of at least 30 cm while the speaker is emitting sound.

The automated mechanism is configured to relocate at least one speaker at a rate of at least 25 cm/S over a distance of at least 100 cm while the speaker is emitting sound.

The entertainment system may further comprise a control configured to coordinate an acoustic signal for the speaker with a drive signal for the automated mechanism.

The automated mechanism may be configured to move the speaker in an arc.

The automated mechanism may be configured to move the speaker along two independent axes of movement, or along three independent axes of movement.

The entertainment system may further comprise an automated motor control configured to relocate the plurality of speakers in coordination with musical phrases.

The entertainment system may further comprise a sensor configured to determine a motion or gesture of a human, wherein the control system is configured to move the speakers coordinated with the motion or gesture of the human.

The control system may be further configured to plan a movement of the plurality of speakers over time, at least 5 seconds in advance of controlling the movement of the plurality of speakers.

The entertainment system may further comprise a human user interface configured to receive a manual control signal for controlling a movement of the plurality of speakers.

The automated mechanism may comprise at least one of a ball screw, a winch which controls a position of a cable, a telescoping assembly, a robotic arm having at least two axes of controlled movement, a robotic arm having at least three axes of controlled movement, a robotic arm having at least four axes of controlled movement, a track, a rotary motor, a linear motor, a gear and rack, a band driven by a wheel, a pneumatic actuator, and a hydraulic actuator.

The plurality of speakers may comprise at least one subwoofer.

The entertainment system may further comprise an optical projector, wherein the automated mechanism is further configured to move the optical projector in coordination with a movement of at least one speaker.

The entertainment may further comprise an optical projector, and a second automated mechanism configured move the optical projector independently of a movement of at least one speaker.

The automated mechanism may be subject to acoustic emissions, and the control system may be further configured to control a movement of the speaker such that the acoustic emissions are masked by an output of the plurality of speakers.

The entertainment system may further comprise a video camera, and an automated control system configured to analyze a video signal from the video camera in real time to generate a control signal for the automated mechanism to coordinate a movement of the plurality of speakers with movements within the video signal.

The entertainment system may further comprise a sensor configured to generate a sensor signal representing an obstruction in a path of at least one speaker, and an automated control configured to control the automated mechanism to prevent contact of the at least one speaker with the obstruction during a movement of the at least one speaker.

The sensor may comprise at least one of a photodetector, a camera, a structured lighting emitter, an infrared sensor, and an ultrasonic sensor.

It is a further object to provide a speaker system, comprising: a column; a sleeve surrounding the column; a tensile member driven by a motor, configured to raise and lower the sleeve; a speaker attached to the sleeve; and a motor control, configured to drive the motor.

The motor may be disposed within the column, within a speaker enclosure.

The system may comprise at least four columns, at least four sleeves, at least four motors, and at least four speakers, further comprising a platform suspended above the columns.

A further object provides a speaker system, comprising: a support structure having a track; a speaker, configured to move along the track; a motor, configured to relocate the speaker along the track; and a motor control, configured to drive the motor for reciprocating movement of the speaker along the track synchronized with an audio source. The track may be non-linear.

The speaker may be downward firing from above a listening space.

The speaker may be upward firing from above a listening space, aimed at an acoustically reflective surface.

Another object provides a method, comprising: receiving an audio source program; determining a trend of the audio source program having a frequency range of 2 Hz to 0.05 Hz; reproducing the audio source program through a speaker concurrently with moving the speaker over a distance of at least 20 cm, which may be synchronized with the trend.

A still further object provides a speaker system, comprising: at least one subwoofer speaker; an actuator, configured to relocate the subwoofer speaker with respect to the floor platform over a distance of at least 0.5 meter while the speaker is emitting sound; and an input port configured to receive an audio program for reproduction by the speaker.

The at least one subwoofer speaker may have an acoustic emission corresponding to the audio program having an output having a sound pressure level of at least 90 dB at 2 meters, having less than 10% total harmonic distortion at 80 Hz.

The actuator may be configured to move the subwoofer speaker with respect to the floor to achieve at least a 3 dB perceived difference in sound level for a normal adult human listener standing on the floor.

Another object provides a sound system comprising at least one low frequency speaker emitting a frequency of 28 hz or lower at a sound pressure level of at least 80 dB, elevated by a supporting structure at least 6 feet over the ground, oriented with the low frequency emissions pointed downwards.

Another object provides a sound system comprising at least one low frequency speaker emitting a frequency of 28 Hz or lower, elevated by a supporting structure at least 6 feet over the ground, oriented where their sound emissions are pointed directly downwards.

The at least one low frequency speaker may comprise a plurality of low frequency speakers, each low frequency speaker being combined into a monoblock where all speakers are touching each other in a speaker array. The monoblock may impair air flow between a front of the speaker array and a back of the speaker array.

Another object provides a speaker system, comprising: a speaker enclosure suspended above a floor; and an actuator, configured to relocate the speaker enclosure with respect to the floor over a sufficient distance and at a sufficient rate to generate a sound pressure wave having a sound pressure level of at least 60 dB at 20 Hz.

### BRIEF DESCRIPTION OF THE DRAWINGS

FIG. 1A shows a side view of the supporting structure with the platform raised high above the dance floor.

FIG. 1B shows a side view of the supporting structure with the platform lowered slightly above the heads of people on the dance floor.

FIG. 2 shows a top perspective view of the speaker arrangement within the supporting structure.

FIG. 3 shows a bottom perspective view of the speaker arrangement within the supporting structure.

FIG. 4 shows a top view of the speaker arrangement.

### DETAILED DESCRIPTION OF THE PREFERRED EMBODIMENTS

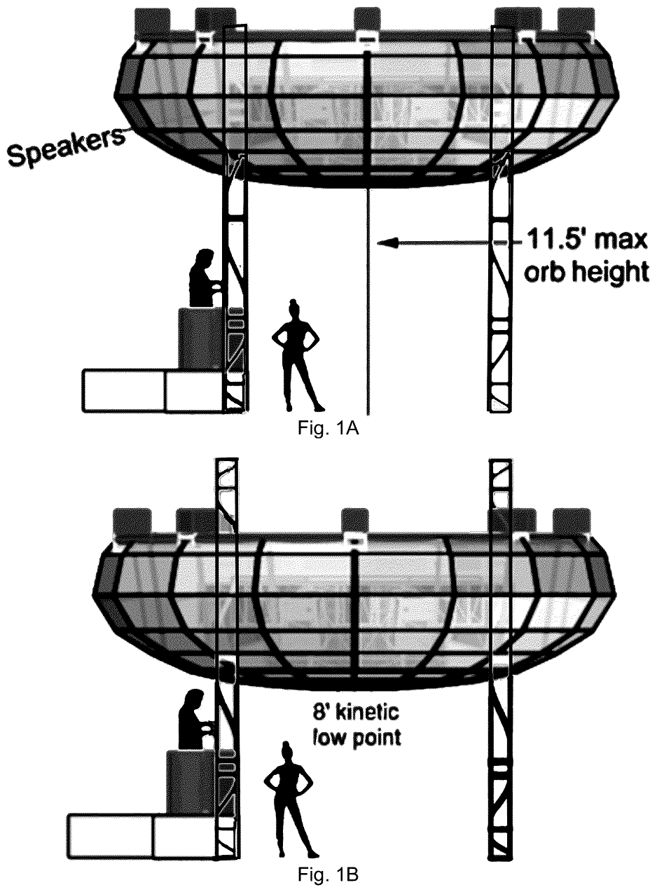

As shown in FIGS. 1-4, a supporting structure is provided that is suspended over a floor. The supporting structure has a set of legs, in this case 4 legs. On top of the legs is a discoid structure, on which a workspace with a floor is provided. The supporting structure is formed of steel, or in some cases aluminum, and therefore can maintain a large load, such as 5000 kg. Further, the trestle structure can effectively damp low frequency vibrations as might result from movement speaker movement.

The speaker may be provided on the supporting legs (providing a vertical axis of movement only), on a track on the radial or circumferential rails of the discoid structure (providing movement along the track and vertically), or more generally from a sub-platform suspended below the discoid structure (providing a full range of movements).

Typically, the motor controls and speaker driver electronics are within the discoid structure, minimizing the external wiring required.

A set of video cameras or optical sensors, with infrared and/or structured lighting, as well as radar sensors track movements on the floor below the supporting structure.

Larger speakers, such as 125 mm and greater diameter drivers, have acoustic enclosures, and are controlled to avoid contact with humans. Smaller speakers may be sufficiently lightweight, and have padded enclosures, to permit them to intrude on the human occupied space.

FIG. 1A shows a side view of the supporting structure with the platform raised high above the dance floor. A winch or synchronized set of winches on the vertical supports raise and lower the overhead platform, with a height of 11.5 feet minimum when raised, and 8 feet minimum when lowered. The platform may be raised and lowered over the course of a minute, corresponding to a rate of 1.67 cm/sec. This rate may be faster or slower. FIG. 1B shows a side view of the supporting structure with the platform lowered slightly above the heads of people on the dance floor.

The platform is held up by a set of four legs, each formed in a trellis structure. The outer face of the platform is toroidal, though the inner portion is populated with speakers. Power and signal will generally be supplied through cables in one or more legs. The legs may be bolted to pads on the floor, or directly to the floor.

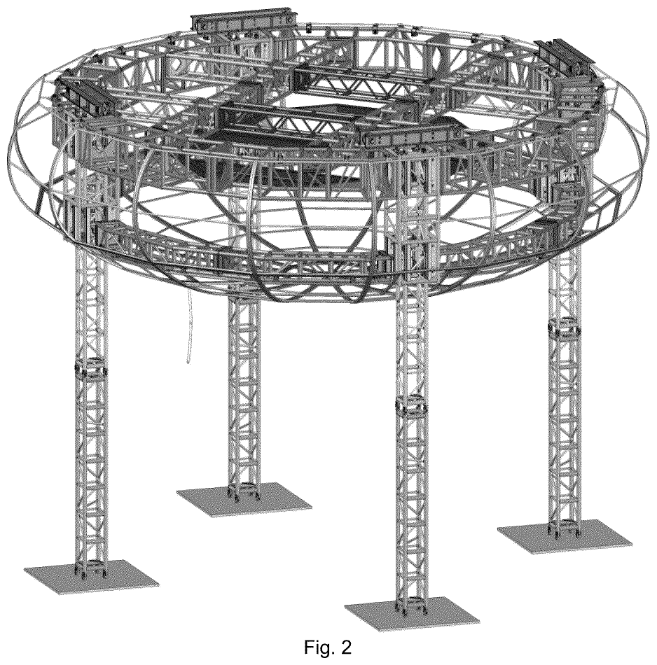

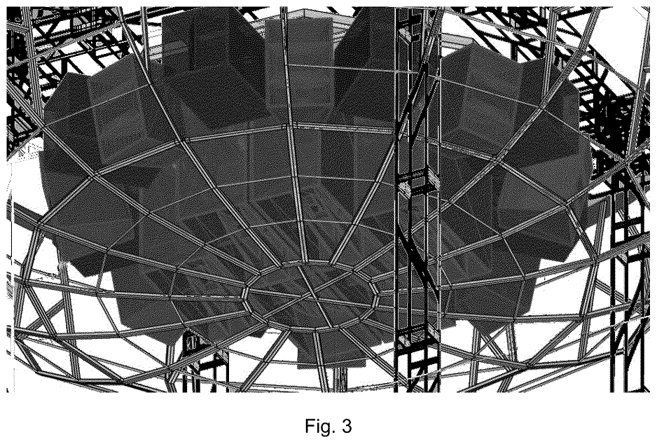

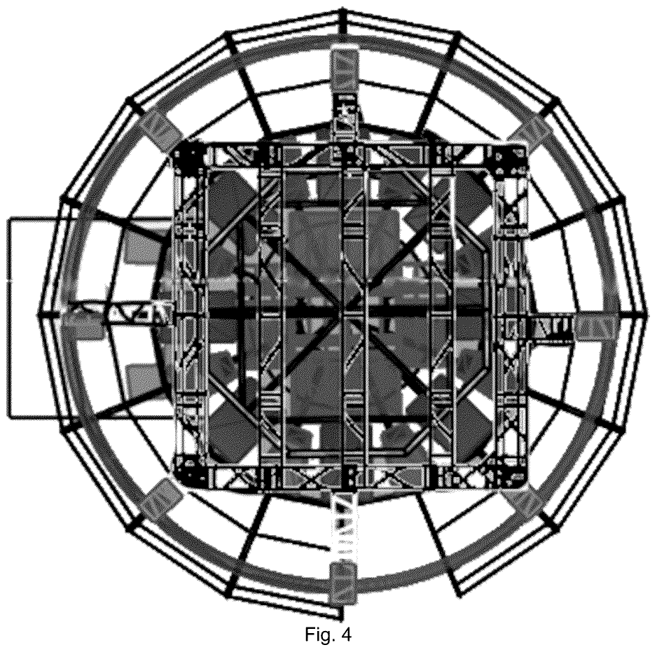

FIG. 2 shows a top perspective view of the speaker arrangement within the supporting structure. FIG. 3 shows a bottom perspective view of the speaker arrangement. FIG. 4 shows a top view of the speaker arrangement. In the center are an array of subwoofers, which in a preferred embodiment are in rectangular enclosures, with the acoustically emissive port facing downward. The enclosures are provided in a 1+2+2+1 arrangement, though other arrangements are feasible. The speaker enclosures are arranged without air gaps between them, though in other arrangements, air gaps may be filled. All of the subwoofers emit the same program material, though the array may have appropriate phase delays between elements as required to remove sonic artifacts. Around the central core of downward facing subwoofers are alternating mid (midrange) and high (tweeter) speakers. In one implementation, the alternating mid speakers may play left and right channels, and the alternating high speakers may play left and right channels, to provide some spatial effects. The intent of the design is to provide an open floor, with 360 degree sound, with uniform sound pressure level and low distortion in the environment under the platform and immediately surrounding the platform.

Typically, the sound pressure level at frequencies low frequencies is above 90 dB, preferably above 96 dB, more preferably above 102 dB, and most preferably with an available SPL of >108 dB at frequencies between 30 and 60 Hz. The same SPL, e.g., 90, 96, 102, or >108 dB may be present at 20 Hz, 25 Hz, 30 Hz, 35 Hz, 40 Hz, 45 Hz, 50 Hz, 55 Hz, 60 Hz, 65 Hz, 70 Hz, 75 Hz, 80 Hz, 90 Hz, and 100 Hz. The crossover between subwoofer and woofer or midrange speakers is generally between 65-125 Hz, and for example, a typical theatre application uses a crossover of 80 Hz. Because the speakers each have their own amplifier (e.g., a monoblock), the crossover may permit overlap of output, and therefore higher available SPL in the crossover range. However, care must be exercised to avoid distortion and interference between the sources, especially if they are not physically coordinated to ensure array phase alignment.

The speaker system may be calibrated using a digital spread spectrum signal (DSSS) output that provides a time-encoded broadband emission, and microphones at various locations. For example, each leg of the support structure may have one or more microphones. Further, the DSSS tuning signal may be emitted during a performance, where it is perceived as noise, to permit frequency and phase equalization as conditions of performance vary. The noise may be maintained 12-30 dB below the performance audio, for example, and may be selectively emitted during passages which themselves appear as noise.

The subwoofers of the system are arranged with the acoustic waves emitted by the array facing downward. The system may be driven during an event at 100-105 dB. The array produces low frequency output without significant multipoint interferences, and for example has a sound intensity which is equalized ±2 dB at 20 Hz across the dance floor.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with law.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The foregoing descriptions are merely examples of the embodiments of this application, but are not intended to limit this application. Any modification, equivalent replacement, or improvement made without departing from the spirit and principle of this application falls within the protection scope of this application.

What is claimed is:

1. An audio system, comprising:
a monoblock speaker array maintained above an open space for congregation of listeners, comprising a plurality of subwoofers in an array defining a surface, each subwoofer being configured to emit sound directly downward toward the ground over a frequency range of at least 30-60 Hz and being mounted in a subwoofer enclosure, the subwoofer enclosures being arranged in a two-dimensional array without intervening air flow space; and
an amplifier for each respective subwoofer;
wherein the monoblock speaker array is configured to subject the open space for congregation of listeners to a uniform sound pressure level of at least 90 dB over the frequency range of at least 30-60 Hz.

2. The audio system according to claim 1, wherein each subwoofer is configured to emit sound directly downward toward the ground over a frequency range of at least 25-80 Hz.

3. The audio system according to claim 1, further comprising an actuator configured to change a height of the monoblock speaker array over the ground by a distance of at least 50 cm at a rate of at least 5 cm/sec while the monoblock speaker array is emitting sound.

4. The audio system according to claim 3, wherein the actuator comprises a plurality of coordinated motors configured to lift and lower the monoblock speaker array with a plurality of cables or screws.

5. The audio system according to claim 3, further comprising a control configured to synchronize a movement of the monoblock speaker array with a musical composition, to change a sound pressure level at a location of a listener in the open space by at least 3 dB.

6. The audio system according to claim 3, wherein the actuator is configured to move the monoblock speaker array along at least two different axes.

7. The audio system according to claim 3, further comprising a sensor configured to determine an object in the open space, and a control system responsive to the sensor configured to control the actuator.

8. The audio system according to claim 1, further comprising:
a second speaker array configured to emit sounds at frequencies above 200 Hz, the second speaker array surrounding the monoblock speaker array; and
at least one amplifier configured to drive the second speaker array.

9. The audio system according to claim 1, further comprising an optical system controller configured to control an optically emissive visual effect.

10. An entertainment system, comprising:
a plurality of speakers in a spatial array without an air gap therebetween, each being configured to emit sound at a frequency of 35 Hz directly downward; and
a mechanism configured to support the spatial array over a floor area;
wherein the spatial array is configured to achieve a sound pressure level at the frequency of 35 Hz of at least 90 dB at the floor area.

11. The entertainment system according to claim 10, wherein the spatial array is configured to achieve a sound pressure level over a range of frequencies of 25-80 Hz of at least dB at the floor area.

12. The entertainment system according to claim 10, further comprising an automated control system, configured to control the mechanism to relocate the plurality of speakers while the speakers are emitting sound, based on a musical composition played through the plurality of speakers, while avoiding a collision with a listener on the floor area.

13. A system, comprising:
a speaker configured to emit sound at a frequency of 30 Hz; and
an actuator, configured to change a height of the speaker with respect to the floor over a distance of at least 50 cm while the speaker is emitting the sound at the frequency of 30 Hz directly downward toward the ground.

14. The system according to claim 13, wherein the actuator comprises a motor configured to lift and lower the speaker with at least one cable or screw.

15. The system according to claim 13, wherein the actuator is configured to maintain the speaker at a height of 3 meters above the ground, and to vary a height of the speaker to change a sound pressure level at the ground by at least 3 dB at 30 Hz.

16. The system according to claim 15, wherein the actuator is further configured to change the height of the speaker to a height of less than 2 meters above the ground.

17. The system according to claim 13, further comprising a control configured to coordinate a drive signal for the actuator with an acoustic signal for reproduction by the speaker.

18. The system according to claim 13, further comprising a sensor configured to determine an obstruction of a movement of the speaker, and a control system configured to control the actuator to move while avoiding the obstruction.

19. The system according to claim 13, further comprising an optical system controller configured to control an optically emissive visual effect in coordination with a movement of the speaker.

20. The system according to claim 13, further comprising a video camera configured to produce a video signal, and an automated control system configured to generate a control signal for the actuator to control a movement of the speaker dependent on the video signal.
